(19) United States
(12) Patent Application Publication
(10) Pub. No.: US 2017/0150212 A1
(43) Pub. Date: May 25, 2017

(54) METHOD AND ELECTRONIC DEVICE FOR ADJUSTING VIDEO

(71) Applicants: LE HOLDINGS (BEIJING) CO., LTD., Beijing (CN); LE SHI INTERNET INFORMATION TECHNOLOGY CORP., BEIJING, BEIJING (CN)

(72) Inventor: Yingjie WANG, Beijing (CN)

(21) Appl. No.: 15/245,024

(22) Filed: Aug. 23, 2016

Related U.S. Application Data
(63) Continuation of application No. PCT/CN2016/089121, filed on Jul. 7, 2016.

(30) Foreign Application Priority Data
Nov. 23, 2015 (CN) 201510818977.9

(51) Int. Cl. H04N 21/44; H04N 5/93; G06T 7/40; H04N 21/4223; G06T 7/20; H04N 21/2187; H04N 21/472; H04N 5/232; G06T 7/60

(52) U.S. Cl. CPC H04N 21/44016; H04N 5/23238; H04N 5/9305; G06T 7/40; G06T 7/60; G06T 7/20; H04N 21/2187; H04N 21/47202; H04N 21/4223; H04N 21/44008; G06F 3/017

(57) ABSTRACT

A method and an electronic device for adjusting a panoramic video, which are intended to play the video more flexibly and realize richer functions. The method includes: binding panoramic image frames of the panoramic video with a spherical model and generating output video frames; receiving an adjusting instruction and converting the adjusting instruction into model adjusting information corresponding to the spherical model; adjusting the output video frames according to the model adjusting information to generate adjusted output video frames.

### CROSS-REFERENCE TO RELATED APPLICATIONS

The present disclosure is a continuation of International Application No. PCT/CN2016/089121 file Jul. 7, 2016, which is based upon and claims priority to Chinese Patent Application No. 201510818977.9, entitled “METHOD AND DEVICE FOR PLAYING VIDEO”, filed on Nov. 23, 2015, the entire contents of all of which are incorporated herein by reference.

### TECHNICAL FIELD

The present disclosure generally relates to the technical field of mobile Internet, and in particular relates to a method and an electronic device for adjusting a video.

### BACKGROUND

At present, a user can access a live video or video-on-demand system to watch videos by means of terminal equipment; the user can watch live broadcasts, or select interested videos to play after making a search according to personal hobbies. For example, the user can access the live video or video-on-demand system to watch video data on a smart phone, a computer, and a smart TV.

In the live video or video-on-demand system of a mobile terminal, video contents that a user can watch depend on video sources. A panoramic video is fluent and clear dynamic video images, which consists of many cascaded panoramic images. Due to a mature panoramic video stitching algorithm and the popularization of panoramic recording equipment at present, more and more panoramic video sources emerge, which makes it possible for a user to watch panoramic videos on a mobile terminal.

### SUMMARY

According to one aspect of the present disclosure, the embodiments of the present disclosure discloses a method for adjusting a video, which includes: binding panoramic image frames of the panoramic video with a spherical model and generating output video frames; receiving an adjusting instruction and converting the adjusting instruction into model adjusting information corresponding to the spherical model; adjusting the output video frames according to the model adjusting information to generate adjusted output video frames.

According to other aspect of the present disclosure, the embodiments of the present disclosure also provide an electronic device for adjusting a video, which includes: at least one processor; and a memory communicably connected with the at least one processor for storing instructions executable by the at least one processor, wherein execution of the instructions by the at least one processor causes the at least one processor to: bind panoramic image frames of a panoramic video with a spherical model and generate output video frames; receive an adjusting instruction and convert the adjusting instruction into model adjusting information corresponding to the spherical model; adjust the output video frames of the panoramic video according to the model adjusting information to generate adjusted output video frames

According to another aspect of the present disclosure, provided is a non-volatile computer-readable storage medium is provided in the embodiments of the disclosure, the non-volatile computer-readable storage medium is stored with computer executable instructions which are used to: bind panoramic image frames of a panoramic video with a spherical model and generating output video frames; receiving an adjust instruction and convert the adjusting instruction into model adjusting information corresponding to the spherical model; and adjusting the output video frames of the panoramic video according to the model adjusting information to generate adjusted output video frames.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a step flow diagram of an embodiment of a method for adjusting a video of the present disclosure.

FIG. 2 is a step flow diagram of another embodiment of a method for adjusting a video of the present disclosure.

FIG. 3 is a structural block diagram of an embodiment of a device for adjusting a video of the present disclosure.

FIG. 4 is a structural block diagram of another embodiment of a device for adjusting a video of the present disclosure.

FIG. 5 is a structural block diagram of a video binding submodule in an optional embodiment of the present disclosure.

FIG. 6 is a structural block diagram of a matrix calculating submodule in an optional embodiment of the present disclosure.

FIG. 7 is a block diagram showing the electronic device for executing the method for adjusting a video.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Obviously, the described embodiments are part of embodiments of the present disclosure, not all embodiments. Based on the embodiments in the present disclosure, all the other embodiments obtained by people ordinarily skilled in the art without creative labor should fall into the scope of protection of the present disclosure.

One core concept of the embodiment of the present disclosure is to bind panoramic image frames of the panoramic video with a spherical model and generate output video frames, receive an adjusting instruction and convert the adjusting instruction into model adjusting information corresponding to the spherical model, and adjust the output video frames according to the model adjusting information to generate adjusted output video frames. Panoramic video sources are correspondingly adjusted and displayed according to adjusting operations of a user, and in such a manner, the panoramic videos can be played more flexibly, and the functions of playing the panoramic videos are enriched.

### A First Embodiment

A method for adjusting a video provided by this embodiment of the present disclosure will be introduced below in detail.

By referring to FIG. 1, illustrated is a step flow diagram of an embodiment of a method for adjusting a panoramic video of the present disclosure. The method may specifically include the steps as follows.

In step S102, panoramic image frames of the panoramic video are bound with a spherical model and output video frames are generated.

Panoramic video source data includes 720-degree or 360-degree panoramic video sources; in other words, a dynamic video may be viewed at random by 360 degrees above and below, and on the left and right of a position of a video camera. The panoramic video source data includes a plurality of panoramic image frames, and requires a three-dimensional model, such as the spherical model, to achieve a 3D (three-dimensional) effect of panoramic playing, which can be realized by binding the three-dimensional model with the panoramic image frames of the panoramic video source data.

In the present embodiment, when a video is played on demand or a live video plays, a 3D video may be played by using panoramic video sources, and therefore, the spherical model may be bound with various panoramic image frames of the panoramic video. After binding, the output video frames may be generated, and a code stream of the output video frames is played in a mobile terminal to realize playing of the corresponding panoramic videos, wherein the mobile terminal is one of computer devices available when moving, including a smart phone, a tablet computer, a vehicle-mounted terminal, and the like.

In step S104, an adjusting instruction is received and converted into model adjusting information corresponding to the spherical model.

This embodiment of the present disclosure is capable of realizing not only playing of a panoramic video in a mobile terminal, but also interaction with the panoramic video in accordance with an adjusting operation of a user, for example, switching view angles for the user at random in accordance with video scenes, freely zooming in or expanding a viewing angle of the video; in this way, the flexibility of video playing is improved in the process of playing a live video or a video on demand, and therefore, the functions of video playing are enabled to be richer. The adjusting instruction corresponding to the adjusting operation of the user may be received, and the content of adjusting, such as rotating, scaling, and the like, is determined according to the adjusting instruction; the adjusting instruction thus is converted to determine the model adjusting information corresponding to the spherical model.

In step S106, the output video frames are adjusted according to the model adjusting information to generate adjusted output video frames.

As the output video frames are bound with the spherical model, mapping may be made to corresponding output video frames according to the model adjusting information, such that the output video frames of the panoramic videos are adjusted to generate the adjusted output video frames, such as switching view angles of the video camera, zooming in or expanding the viewing angle of the panoramic video, or the like.

In conclusion, the panoramic image frames of the panoramic video are bound with the spherical model and the output video frames are generated; the adjusting instruction is received and converted into the model adjusting information corresponding to the spherical model; the output video frames are adjusted according to the model adjusting information to generate the adjusted output video frames. Panoramic video sources are correspondingly adjusted and displayed according to the adjusting operations of the user, and in such a manner, the panoramic videos can be played more flexibly, and the functions of playing the panoramic videos are enriched.

### A Second Embodiment

A method for adjusting a video provided by this embodiment of the present disclosure will be introduced below in detail.

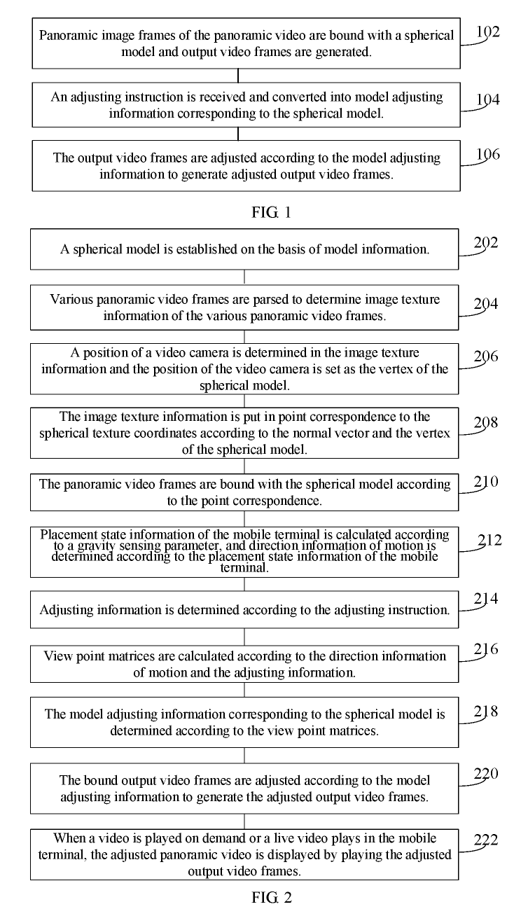

By referring to FIG. 2, illustrated is a step flow diagram of another embodiment of a method for adjusting a panoramic video of the present disclosure; the method may specifically include the steps as follows.

In step S202, a spherical model is established on the basis of model information, wherein the model information includes a vertex, a normal vector and spherical texture coordinates of the spherical model.

In step S204, various panoramic video frames are parsed to determine image texture information of the various panoramic video frames.

To bind the panoramic video frames with the spherical mode, it needs to firstly obtain the data information of the panoramic video frames and determine the model information of the spherical model; the panoramic video frames are mapped onto the spherical model according to the data information and the model information, thereby realizing binding. Hence, before binding, each panoramic video frame may be parsed to determine the image texture information of each panoramic video frame, wherein texture is an important visual clue and commonly exists in images; the image texture information includes hue elements forming the texture and a correlation of the hue elements, for example a texture ID (Identity). The model information of the spherical model is determined as required; for example, a vertex, a normal vector and spherical texture coordinates of the spherical model are set first, and then the spherical model is established. The spherical model is established on the basis of the model information.

The panoramic video frames then may be bound with the spherical model according to the texture information; mapping is performed on the texture information and the spherical model to bind the panoramic video frames with the spherical model, which includes the following specific steps:

In step S206, a position of a video camera is determined in the image texture information and the position of the video camera is set as the vertex of the spherical model.

In step S208, the image texture information is put in point correspondence to the spherical texture coordinates according to the normal vector and the vertex of the spherical model.

In step S210, the panoramic video frames are bound with the spherical model according to the point correspondence.

In order to realize binding of the panoramic video frames with the spherical model, it needs to put the image texture information of the panoramic video frames in correspondence to the model information of the spherical model. The position of the video camera for shooting the panoramic video frames can be determined by analyzing the hue elements forming the texture and the correlation of the hue elements in the image texture information. The position of the video camera is set as the vertex of the spherical model; for example, the position of the video camera is set to coordinates (0, 0, 0). The correspondence of the position of the video camera in the image texture information to the vertex of the spherical model thus is realized.

Next, each panoramic video frame may be divided into a plurality of fragments of a specific geometric shape; generally, the panoramic video frame is divided into fragments of a plurality of triangles for the sake of convenient division. The information of three vertexes of the triangle is determined according to the texture information, and the vertex information of a plurality of triangles is put into point correspondence to the spherical texture coordinates such as (0, 0) to (1, 1); the panoramic video frame thus is bound with the spherical model according to the point correspondence; binding may be realized through a function opengl.

When a video is played on demand or a live video plays in a mobile terminal, after the output video frames are obtained by binding the panoramic image frames with the spherical model in the above manner, the output video frames may be played to display the panoramic video. In the process when a user watches, if the user wants to adjust a watching angle, details, and the like, the output video frames can be adjusted through the following specific adjustment steps:

In step S212, placement state information of the mobile terminal is calculated according to a gravity sensing parameter, and direction information of motion is determined according to the placement state information of the mobile terminal.

The gravity sensing parameter of the mobile terminal is obtained, and the placement state information, such as vertical screen, inverted vertical screen, transverse screen or inverted transverse screen, of the mobile terminal is calculated according to components of the gravity sensing parameters in x, y and z directions in a spherical model coordinate system. Direction information of motion of a gyroscope and a touch screen in the mobile terminal is determined by means of the placement state information of the device; for example, if the touch screen is transverse screen, the values of x and y are input correctly on the touch screen; if the touch screen is vertical screen, the values of x and y are exchanged; if the touch screen is inverted transverse screen, the values of x and z are input correctly on the touch screen; if the touch screen is inverted vertical screen, the values of x and z are exchanged.

In the present embodiment, the operation of converting the adjusting instruction into the model adjusting information corresponding to the spherical model includes calculating viewpoint matrices according to the adjusting instruction; determining the model adjusting information corresponding to the spherical model in accordance with the viewpoint matrices. That is to say, after the adjusting instruction is received, the view point matrices may be calculated according to the adjusting instruction, and then the model adjusting information corresponding to the spherical model is calculated by using the view point matrices; this process includes the specific steps as follows.

In step S214, adjusting information is determined according to the adjusting instruction.

In an embodiment of the present disclosure, the adjusting instruction includes: a single-finger adjusting instruction and/or a two-finger adjusting instruction; the adjusting information includes steps: rotating information and/or scaling information; the adjusting information is determined according to the adjusting instruction includes: a rotating direction and a rotating angle of a gyroscope are determined according to the single-finger adjusting instruction, and the rotating direction and the rotating angle are regarded as the rotating information; and/or the scaling information is determined according to the two-finger adjusting instruction to a touch screen.

The adjusting information is determined according to the adjusting instruction corresponding to an adjusting operation of a user may include three cases as below.

For the first case, the adjusting operation of the user includes single finger sliding to realize a function of switching a view angle. The corresponding operating command is the single-finger adjusting instruction, and the corresponding adjusting information is the rotating information. The mobile terminal measures the switching of the view angle, namely the rotating information, by means of the gyroscope. That is to say, the rotating direction and the rotating angle of the gyroscope are determined according to the single-finger adjusting instruction, and the rotating direction and the rotating angle are regarded as the rotating information.

For the second case, the adjusting operation of the user includes two-finger nipping to realize a function of zooming in or expanding a viewing angle of a panoramic video. The operating command corresponding to the adjusting operation is the two-finger adjusting instruction, and the corresponding adjusting information is the scaling information. The mobile terminal determines zooming-in or expansion, namely the scaling information of the view angle by means of sensed information of the touch screen. That is to say, the scaling information is determined according to the two-finger adjusting instruction to the touch screen.

For the third case, the adjusting operations of the user include single finger sliding to switch a view angle and two-finger nipping to realize zooming-in or expansion of a viewing angle of a panoramic video. The operating commands corresponding to the adjusting operations of the user are the single finger adjusting instruction and the two-finger adjusting instruction, and the corresponding adjusting information is the rotating information and the scaling information. That is to say, the rotating direction and the rotating angle of the gyroscope are determined according to the single-finger adjusting instruction, and the rotating direction and the rotating angle are regarded as the rotating information; and the scaling information is determined according to the two-finger adjusting instruction to the touch screen.

In step S216, the viewpoint matrices are calculated according to the direction information of motion and the adjusting information.

The viewpoint matrices include a current conversion matrix, a projection matrix, an orientation matrix and a final conversion matrix. Firstly, the current conversion matrix of the current output video frame is obtained, and then the orientation matrix is calculated according to the direction information of motion of the gyroscope and the touch screen and the rotating information of the gyroscope; the projection matrix is calculated according to the scaling information of the touch screen, and finally, the final conversion matrix is obtained.

In step S218, the model adjusting information corresponding to the spherical model is determined according to the viewpoint matrices.

In step S220, the bound output video frames are adjusted according to the model adjusting information to generate the adjusted output video frames.

The information of each point, for example, coordinate values of each point, in the current conversion matrix is obtained, and then the model adjusting information on the spherical model is determined. If a certain point is selected, the current coordinate values are determined according to the current conversion matrix; the coordinate values after rotating processing are determined through the conversion of the orientation matrix; the coordinate values after scaling processing are obtained through the conversion of the projection matrix; the coordinate values of each point of the bound output video frames are adjusted according to the model adjusting information, namely corresponding relations of the coordinate values between the four matrices in the viewpoint matrices, and the adjusted output video frames are generated.

In step S222, when a video is played on demand or a live video plays in the mobile terminal, the adjusted panoramic video is displayed by playing the adjusted output video frames.

When a video is played on demand or a live video plays in the mobile terminal, the panoramic video may be adjusted by means of the adjusting instruction; after the adjustment of the output video frames is completed, the adjusted output video frames may be played to display the adjusted panoramic video. Panoramic video sources are correspondingly adjusted and displayed according to the adjusting operations of the user in this embodiment of the present disclosure, and in such a manner, effective interaction of the user with the panoramic video sources and the advantages of the panoramic videos with respect to common videos are reflected.

In conclusion, the panoramic video frames are parsed to determine the image texture information of the various panoramic video frames, and the image texture information is put in point correspondence to the graphic texture coordinates according to the normal vector and the vertex of the spherical mode, thereby realizing binding of the panoramic video frames and the spherical modes. By means of the point correspondence of the image texture information to the spherical texture coordinates, the binding process becomes simpler and more accurate.

It needs to be noted that with respect to the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are embodiments, and the actions involved therein are not necessary for the embodiments of the present disclosure.

### A Third Embodiment

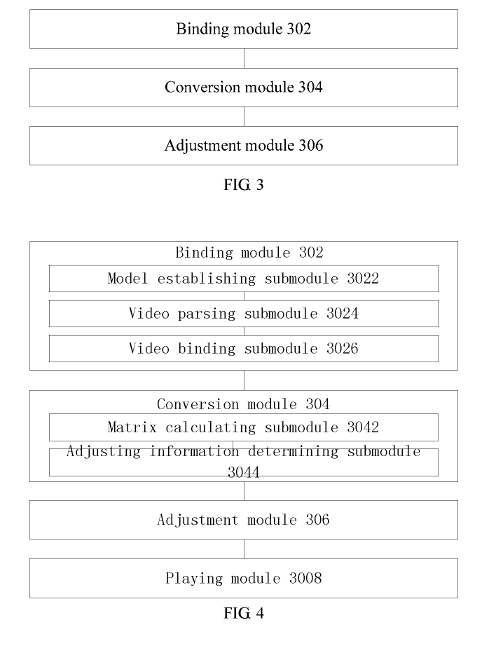

By referring to FIG. 3, illustrated is a structural block diagram of an embodiment of a device for adjusting a video of the present disclosure; the device may specifically include the following modules: a binding module 302, a conversion module 304, and an adjustment module 306.

The binding module 302 displays an adjusted panoramic video by playing adjusted output video frames, when a video is played on demand or a live video plays in a mobile terminal.

The conversion module 304 receives an adjusting instruction and converts the adjusting instruction into model adjusting information corresponding to the spherical model.

The adjustment module 306 adjusts the output video frames of the panoramic video according to the model adjusting information to generate the adjusted output video frames.

In conclusion, the panoramic image frames of the panoramic video are bound with the spherical model and the output video frames are generated; the adjusting instruction is received and converted into the model adjusting information corresponding to the spherical model; the output video frames are adjusted according to the model adjusting information to generate the adjusted output video frames. Panoramic video sources are correspondingly adjusted and displayed according to the adjusting operations of the user, and in such a manner, the panoramic videos can be played more flexibly, and the functions of playing the panoramic videos are enriched.

By referring to FIG. 4, illustrated is a structural block diagram of another embodiment of a device for adjusting a video of the present disclosure. The device may specifically include the following modules: a binding module 302, a conversion module 304, an adjustment module 306, and a playing module 308.

The binding module 302 displays an adjusted panoramic video by playing adjusted output video frames when a video is played on demand or a live video plays in a mobile terminal.

In another optional embodiment of the present disclosure, the binding module 302 includes a model establishing submodule 3022, a video parsing submodule 3024, and a video binding submodule 3026.

The model establishing submodule 3022 establishes the spherical model on the basis of model information, wherein the model information includes a vertex, a normal vector and spherical texture coordinates of the spherical model.

The video parsing submodule 3024 parses various panoramic video frames to determine image texture information of the various panoramic video frames.

The video binding submodule 3026 binds the panoramic video frames with the spherical model according to the texture information.

As shown in FIG. 5, in another optional embodiment of the present disclosure, the video binding submodule 3026 includes a vertex determining unit 30262, a texture corresponding unit 30264, and a video binding unit 30266.

The vertex determining unit 30262 determines a position of a video camera in the image texture information and set the position of the video camera as the vertex of the spherical model.

The texture corresponding unit 30264 puts the image texture information in point correspondence to the spherical texture coordinates according to the normal vector and the vertex of the spherical model.

The video binding unit 30266 binds the panoramic video frames with the spherical model according to the point correspondence.

The conversion module 304 receives an adjusting instruction and converts the adjusting instruction into model adjusting information corresponding to the spherical model.

In another optional embodiment of the present disclosure, the conversion module 304 includes a matrix calculating submodule 3042 and an adjusting information determining submodule 3044.

The matrix calculating submodule 3042 calculates viewpoint matrices according to the adjusting instruction.

The adjusting information determining submodule 3044 determines the model adjusting information corresponding to the spherical model in accordance with the viewpoint matrices.

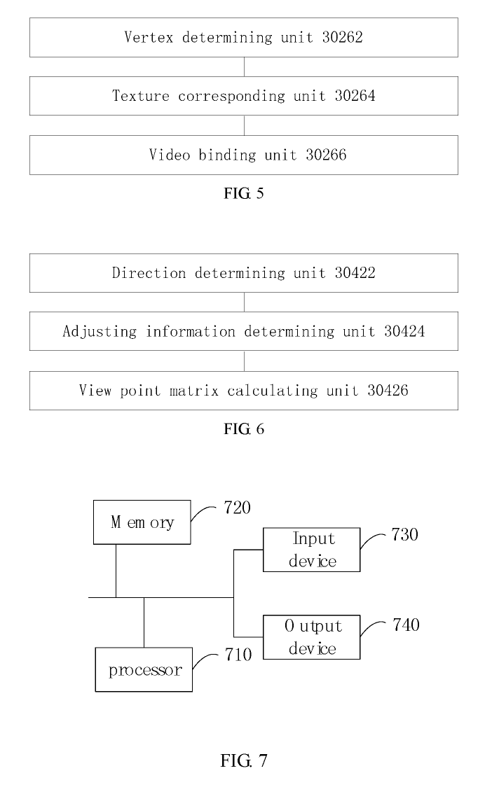

As shown in FIG. 6, in another optional embodiment of the present disclosure, the matrix calculating submodule 3042 includes a direction determining unit 30422, an adjusting information determining unit 30424, and a viewpoint matrix calculating unit 30426.

The direction determining unit 30422 calculates placement state information of a mobile terminal according to a gravity sensing parameter, and determine direction information of motion according to the placement state information of the mobile terminal.

The adjustment information determining unit 30424 determines the adjusting information according to the adjusting instruction.

The viewpoint matrix calculating unit 30426 calculates the viewpoint matrices according to the direction information of motion and the adjusting information.

In another optional embodiment of the present disclosure, the adjusting instruction therein includes a single-finger adjusting instruction and/or a two-finger adjusting instruction; the adjusting information includes rotating information and/or scaling information.

The adjusting information determining unit 30424 determines a rotating direction and a rotating angle of a gyroscope according to the single-finger adjusting instruction, and regards the rotating direction and the rotating angle as the rotating information; and/or determines the scaling information according to the two-finger adjusting instruction to a touch screen.

The adjustment module 306 adjusts the output video frames of the panoramic video according to the model adjusting information to generate the adjusted output video frames.

The playing module 308 displays an adjusted panoramic video by playing adjusted output video frames when a video is played on demand or a live video plays in a mobile terminal.

In conclusion, the panoramic video frames are parsed to determine the image texture information of the various panoramic video frames, and the image texture information is put in point correspondence to the graphic texture coordinates according to the normal vector and the vertex of the spherical mode, thereby realizing binding of the panoramic video frames and the spherical modes. By means of the point correspondence of the image texture information to the spherical texture coordinates, the binding process becomes simpler and more accurate.

For the device embodiments, as they are substantially similar to the method embodiments, the descriptions are relatively simple; for the relevant parts, just see part of descriptions of the method embodiments.

Each embodiment in the description is described in a progressive manner. Descriptions emphasize on the differences of each embodiment from other embodiments, and same or similar parts of various embodiments just refer to each other.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

Embodiments of the present disclosure further provide a non-volatile computer-readable storage medium, the non-volatile computer-readable storage medium is stored with computer executable instructions which are configured to perform any of the embodiments described above of the method for adjusting a video.

FIG. 7 is a structural schematic diagram showing the electronic device for executing the method for adjusting a video above. As shown in FIG. 7, the electronic device includes:
one or more processors 710 and memories 720, in FIG. 7, one processor 710 is taken as an example.

The electronic device for executing the method for adjusting the video may include: an input device 730 and an output device 740.

The processor 710, the memory 720, the input device 730 and the output device 740 are connected through buses or other connecting ways. In FIG. 7, a bus connection is taken as an example.

The memory 720 is a non-transitory computer readable storage medium which may be used to store non-transitory software program, non-transitory computer-executable program and modules such as the program instructions/modules (such as the binding module 302, the conversion module 304, and the adjustment module 306 shown in FIG. 3) corresponding to the method for adjusting the video according to the embodiment of the present disclosure. The processor 710 executes various functions and applications of the electronic device and performs data processing by operating the non-transitory software programs, instructions and modules stored in the memory 720, that is, executes the method for adjusting the video according to the method embodiments above.

The memory 720 may include a program storage section and a data storage section. Wherein the program storage section may store operating system and application needed by at least one function, and the data storage section may store the established data according to the device for adjusting the video. In addition, the memory 720 may include a high-speed random access memory, and may also include a non-transitory memory such as at least a disk memory device, flash memory device or other non-transitory solid-state storage devices. In some embodiments, the memory 720 may include a remote memory away from the processor 710. The remote memory may be connected to the device for adjusting the video via network. The network herein may include Internet, interior network in a company, local area network, mobile communication network and the combinations thereof.

The input device 730 may receive input numbers or characteristics information, and generate key signal input relative to the user setting and function control of the device for adjusting the video. The output device 740 may include display devices such as a screen.

The one or more modules are stored in the memory 720, when executed by the one or more processors 710, the methods for adjusting the video in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

A skilled person in the art should know that, the embodiment of the present disclosure may be provided with method, device or computer program products. Therefore, the embodiment of the present disclosure may be totally hardware embodiment, totally software embodiment, and the combination of hardware and software embodiments. In addition, the embodiment of the invention may be one or more computer program product form which is executed on computer readable storage medium (including but not limiting as compact disk, CD-ROM, optical storage and so on) including computer readable program codes.

The embodiments of the present disclosure are described with reference to the flow diagrams and/or the block diagrams of the method, the terminal device (system), and the computer program product according to the embodiments of the present disclosure. It should be appreciated that computer program commands may be adopted to implement each flow and/or block in each flow diagram and/or each block diagram, and the combination of the flows and/or the blocks in each flow diagram and/or each block diagram. These computer program commands may be provided to a universal computer, a special purpose computer, an embedded processor or a processor of another programmable data processing terminal equipment to generate a machine, such that the commands executed by the computer or the processor of another programmable data processing terminal equipment create a device for implementing functions specified in one flow or multiple flows of each flow diagram and/or one block or multiple blocks of each block diagram.

These computer program commands may also be stored in a computer readable memory that is capable of guiding the computer or another programmable data processing terminal equipment to work in a specified mode, such that the commands stored in the computer readable memory create a manufacture including a command device for implementing functions specified in one flow or multiple flows of each flow diagram and/or one block or multiple blocks of each block diagram.

These computer program commands may be loaded on the computer or another programmable data processing terminal equipment, such that a series operation steps are executed on the computer or another programmable data processing terminal equipment to generate processing implemented by the computer; in this way, the commands executed on the computer or another programmable data processing terminal equipment provide steps for implementing functions specified in one flow or multiple flows of each flow diagram and/or one block or multiple blocks of each block diagram.

Although the embodiments of the present disclosure is described, a skilled person in the art may change or modify the embodiment once he or she knows the basic inventive concepts. Therefore, the appended claims are intended to be explained as the embodiments and all modification and amendments within the scope and range of the present disclosure.

At last, it should be noted that, in the present disclosure, the relational terms such as the first and the second are merely used to separate one entity from another entity, rather than requiring or implying practical relation or sequence of these entities and procedures. In addition, the term comprise or include or variant forms thereof represents the is of including but not limiting, thusly the process, method, product or apparatus which includes essentials may not only include those essentials, but also include other essentials which are not listed definitely, or may include the initial essentials of the process, method, product or apparatus. In the case that no more limitation is given, the essentials limited by the term “including” does not preclude other same or similar essentials exist in the process, method, product or apparatus.

The method for adjusting a panoramic video and a device for adjusting a panoramic video provided by the present disclosure are introduced above in detail. In this text, specific examples are utilized to elaborate the principle and the embodiments of the present disclosure; the above descriptions of the embodiments are merely intended to help understanding the method of the present disclosure and the core concept thereof; meanwhile, for a person ordinarily skilled in the art, alterations may be made to the specific embodiments and the application scope according to the concept of the present disclosure. In conclusion, the contents of this description should not be understood as limitations to the present disclosure.

What is claimed is:

1. A method for adjusting a video, comprising:
binding panoramic image frames of a panoramic video with a spherical model and generating output video frames;
receiving an adjusting instruction and converting the adjusting instruction into model adjusting information corresponding to the spherical model;
adjusting the output video frames of the panoramic video according to the model adjusting information to generate adjusted output video frames.

2. The method according to claim 1, wherein the binding the panoramic image frames of the panoramic video with the spherical model comprises:
establishing the spherical model on the basis of model information, wherein the model information comprises a vertex, a normal vector and spherical texture coordinates of the spherical model;
parsing panoramic video frames of the panoramic video to determine image texture information of the panoramic video frames;
binding the panoramic video frames with the spherical model according to the texture information.

3. The method according to claim 2, wherein the binding the panoramic video frames with the spherical model according to the texture information comprises:
determining a position of a video camera in the image texture information and setting the position of the video camera as the vertex of the spherical model;
putting the image texture information in point correspondence to the spherical texture coordinates according to the normal vector and the vertex of the spherical model;
binding the panoramic video frames with the spherical model according to the point correspondence.

4. The method according to claim 1, wherein the converting the adjusting instruction into the model adjusting information corresponding to the spherical model comprises:
calculating viewpoint matrices according to the adjusting instruction;
determining the model adjusting information corresponding to the spherical model in accordance with the viewpoint matrices.

5. The method according to claim 4, wherein the calculating the viewpoint matrices according to the adjusting instruction comprises:
calculating placement state information of a mobile terminal according to a gravity sensing parameter, and determining direction information of motion according to the placement state information of the mobile terminal;
determining adjusting information according to the adjusting instruction;
calculating the viewpoint matrices according to the direction information of motion and the adjusting information.

6. The method according to claim 5, wherein the adjusting instruction comprises: a single-finger adjusting instruction and/or a two-finger adjusting instruction; the adjusting information comprises rotating information and/or scaling information;
the determining the adjusting information according to the adjusting instruction comprises:
determining a rotating direction and a rotating angle of a gyroscope according to the single-finger adjusting instruction, and regarding the rotating direction and the rotating angle as the rotating information; or
determining the scaling information according to the two-finger adjusting instruction to a touch screen.

7. The method according to claim 1, further comprising:
displaying the adjusted panoramic video by playing the adjusted output video frames, when a video on demand or a live video is played in the mobile terminal.

8. An electronic device, comprising:
at least one processor; and
a memory communicably connected with the at least one processor for storing instructions executable by the at least one processor, wherein execution of the instructions by the at least one processor causes the at least one processor to:
bind panoramic image frames of a panoramic video with a spherical model and generating output video frames;
receive an adjusting instruction and converting the adjusting instruction into model adjusting information corresponding to the spherical model;
adjust the output video frames of the panoramic video according to the model adjusting information to generate adjusted output video frames.

9. The electronic device according to claim 8, wherein the step to bind the panoramic image frames of the panoramic video with the spherical model comprises:
establishing the spherical model on the basis of model information, wherein the model information comprises a vertex, a normal vector and spherical texture coordinates of the spherical model;
parsing various panoramic video frames to determine image texture information of the various panoramic video frames;
binding the panoramic video frames with the spherical model according to the texture information.

10. The electronic device according to claim 9, wherein the step to bind the panoramic video frames with the spherical model according to the texture information comprises:
determining a position of a video camera in the image texture information and setting the position of the video camera as the vertex of the spherical model;
putting the image texture information in point correspondence to the spherical texture coordinates according to the normal vector and the vertex of the spherical model;
binding the panoramic video frames with the spherical model according to the point correspondence.

11. The electronic device according to claim 8, wherein the step to receive an adjusting instruction and converting the adjusting instruction into model adjusting information corresponding to the spherical model comprises:
calculating viewpoint matrices according to the adjusting instruction;
determining the model adjusting information corresponding to the spherical model in accordance with the viewpoint matrices.

12. The electronic device according to claim 11, wherein the step to calculate the viewpoint matrices according to the adjusting instruction comprises:
calculating placement state information of a mobile terminal according to a gravity sensing parameter, and determining direction information of motion according to the placement state information of the mobile terminal;
determining the adjusting information according to the adjusting instruction;
calculating the viewpoint matrices according to the direction information of motion and the adjusting information.

13. The electronic device according to claim 12, wherein the adjusting instruction comprises: a single-finger adjusting instruction and/or a two-finger adjusting instruction; the adjusting information comprises rotating information and/or scaling information;
the step to determine the adjusting information according to the adjusting instruction comprises: determining a rotating direction and a rotating angle of a gyroscope according to the single-finger adjusting instruction, and regarding the rotating direction and the rotating angle as the rotating information; or determining the scaling information according to the two-finger adjusting instruction to a touch screen.

14. The electronic device according to claim 8, wherein at least one processor is further caused to:
display the adjusted panoramic video by playing the adjusted output video frame when a video is played on demand or a live video plays in a mobile terminal.

15. A non-transitory computer-readable medium storing executable instructions that, when executed by an electronic device, cause the electronic device to:
bind panoramic image frames of a panoramic video with a spherical model and generating output video frames;
receive an adjusting instruction and converting the adjusting instruction into model adjusting information corresponding to the spherical model;
adjust the output video frames of the panoramic video according to the model adjusting information to generate adjusted output video frames.

16. The non-transitory computer-readable medium according to claim 14, wherein the step to bind the panoramic image frames of the panoramic video with the spherical model comprises:
establishing the spherical model on the basis of model information, wherein the model information comprises a vertex, a normal vector and spherical texture coordinates of the spherical model;
parsing various panoramic video frames to determine image texture information of the various panoramic video frames;
binding the panoramic video frames with the spherical model according to the texture information.

17. The non-transitory computer-readable medium according to claim 16, wherein the step to bind the panoramic video frames with the spherical model according to the texture information comprises:
determining a position of a video camera in the image texture information and setting the position of the video camera as the vertex of the spherical model;
putting the image texture information in point correspondence to the spherical texture coordinates according to the normal vector and the vertex of the spherical model;
binding the panoramic video frames with the spherical model according to the point correspondence.

18. The non-transitory computer-readable medium according to claim 15, wherein the step to receive an adjusting instruction and converting the adjusting instruction into model adjusting information corresponding to the spherical model comprises:
calculating viewpoint matrices according to the adjusting instruction;
determining the model adjusting information corresponding to the spherical model in accordance with the viewpoint matrices.

19. The non-transitory computer-readable medium according to claim 18, wherein the step to calculate the viewpoint matrices according to the adjusting instruction comprises:
calculating placement state information of a mobile terminal according to a gravity sensing parameter, and determining direction information of motion according to the placement state information of the mobile terminal;
determining the adjusting information according to the adjusting instruction;
calculating the viewpoint matrices according to the direction information of motion and the adjusting information.

20. The non-transitory computer-readable medium according to claim 19, wherein the adjusting instruction comprises: a single-finger adjusting instruction and/or a two-finger adjusting instruction; the adjusting information comprises rotating information and/or scaling information;
the step to determine the adjusting information according to the adjusting instruction comprises: determining a rotating direction and a rotating angle of a gyroscope according to the single-finger adjusting instruction, and regarding the rotating direction and the rotating angle as the rotating information; or determining the scaling information according to the two-finger adjusting instruction to a touch screen.
